(19) United States
(12) Patent Application Publication
(10) Pub. No.: US 2018/0285444 A1
(43) Pub. Date: Oct. 4, 2018

(54) REWRITING CONTEXTUAL QUERIES

(71) Applicant: Google Inc., Mountain View, CA (US)

(72) Inventors: Ajay Joshi, Mountain View, CA (US); Yang-hua Chu, Menlo Park, CA (US); John Eric Hoffmann, Los Angeles, CA (US); Gil Simha Briskin, Petach Tikva (IL)

(21) Appl. No.: 14/449,409

(22) Filed: Aug. 1, 2014

Related U.S. Application Data
(60) Provisional application No. 62/010,316, filed on Jun. 10, 2014.

(51) Int. Cl. G06F 17/30

(52) U.S. Cl. CPC G06F 17/30654

(57) ABSTRACT

Methods, systems, and apparatus, including computer programs encoded on a computer storage medium, for rewriting contextual queries. In one aspect, a method includes receiving a first query for a user session, determining contextual data associated with the first query, receiving a second query subsequent to the first query for the user session, determining that the second query is associated with the contextual data, determining that the second query corresponds to a particular template determined based on at least one of the contextual data or the second query, generating a third query based on the particular template, the contextual data, and the second query, and providing the third query as an input for an action that is responsive to the second query.

### CROSS-REFERENCE TO RELATED APPLICATIONS

This application claims priority to pending U.S. Provisional Application Ser. No. 62/010,316, filed Jun. 10, 2014, the entire contents of which are hereby incorporated by reference.

### BACKGROUND

This specification relates to natural language processing.

The Internet provides access to a wide variety of resources, for example, video files, image files, audio files, or Web pages, including content for particular subjects, book articles, or news articles. A search system can select one or more resources in response to receiving a search query. A search query is data that a user submits to a search engine to satisfy the user's informational needs. The search queries can be, for example, in the form of text, audio, or video. The search system selects and scores resources, e.g., based on their relevance to the search query and on their importance relative to other resources to provide search results. The search results are typically ordered according to the scores and presented according to this order.

### SUMMARY

This specification describes a search system that enables deep context understanding for queries, e.g., for incomplete queries or queries with little log support. The search system can rewrite current queries based on grammar-based templates and contextual data associated with previous queries in user sessions. The search system can reliably trigger corresponding actions responsive to the current queries.

In general, one innovative aspect of the subject matter described in this specification can be embodied in methods that include the actions of receiving a first query for a user session; determining contextual data associated with the first query, the contextual data including a search result responsive to the first query and metadata associated with the first query and the search result; receiving a second query for the user session, the second query being different from the first query and subsequent to the first query; determining that the second query is associated with the contextual data; determining that the second query corresponds to a particular template, the particular template being determined based on at least one of the contextual data or the second query; generating a third query based on the particular template, the contextual data, and the second query; and providing the third query as an input for an action that is responsive to the second query. Other embodiments of this aspect include corresponding computer systems, apparatus, and computer programs recorded on one or more computer storage devices, each configured to perform the actions of the methods. For a system of one or more computers to be configured to perform particular operations or actions means that the system has installed on it software, firmware, hardware, or a combination of them that in operation cause the system to perform the operations or actions. For one or more computer programs to be configured to perform particular operations or actions means that the one or more programs include instructions that, when executed by data processing apparatus, cause the apparatus to perform the operations or actions.

The foregoing and other embodiments can each optionally include one or more of the following features, alone or in combination. For instance, a conversational search system may receive the second query immediately subsequent to the first query without an intervening query and within a predetermined period of time for the user session. The conversational search system may determine one or more templates based on the contextual data and respective grammar rules, parse the second query, and select the particular template from the one or more templates based on a result of parsing the second query.

In some implementations, the conversational search system determines a plurality of templates based on respective vertical categories, respective subjects, and respective grammar rules. The conservational search system may determine that the second query refers to a specific subject and a specific vertical category based on at least one of the second query or the contextual data, identify one or more specific templates associated with the specific subject and the specific vertical category from the plurality of templates, determine that the second query has a particular grammar rule, and select the particular template from the one or more specific templates based on the particular grammar rule.

In some cases, the conservational search system determines that the second query is associated with the contextual data by determining that the second query lacks additional information required for performing the action. The conservational search system may generate a third query by determining the additional information based on the contextual data. In some examples, the conservational search system determines that the first query refers to an entity, and the additional information for the second query includes a corresponding pronoun for the entity. The conservational search system may determine that at least one of the first query or the search result responsive to the first query is associated with a first tense and determine that the second query is associated with the contextual data by determining that a second tense for the second query corresponds to the first tense for the first query.

In some examples, the conservational search system determines information for one or more labels in the particular template based on the second query and the contextual data, and generates the third query based on the determined information and the particular template. The conservational search system may identify one or more supporting grammar rules associated with the one or more labels and generate the third query based on the one or more supporting grammar rules. The third query may have a particular grammar rule corresponding to the particular template, and the particular grammar rule is different from a grammar rule for the first query. The action may include at least one of a search action, a reminder action, or a navigation action.

Particular embodiments of the subject matter described in this specification can be implemented so as to realize one or more of the following advantages. First, search system enables deep context understanding for queries. For example, the search system can determine implicit relationship between sequential queries, and/or implicit actions for queries. The search system also determines queries with little log support, e.g., based on grammar rules. Second, the search system can achieve high reliability for sets of vertical categories and/or subjects, e.g., local search, reminders, weather, sports, flights. The search system can determine suitable predetermined and grammar-based templates for queries and trigger corresponding actions responsive to the queries. Third, the search system can rewrite a current query based on contextual data associated with previous queries, which can reduce the amount of user input on a user device. The search system also enables a user to input queries in a more fluid, conversational manner, which results in ease of use and can enhance user experience. Fourth, the search system is very efficient with quick response, e.g., by determining suitable templates for queries from predetermined templates. Fifth, the search system can be extensible to any suitable language besides English.

The details of one or more embodiments of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is block diagram of an environment in which a search engine rewrites contextual queries.

FIG. 2 is a flow diagram of an example process performed by the search engine of FIG. 1.

FIG. 3 is a flow diagram of an example process performed by the search engine of FIG. 1.

Like reference numbers and designations in the various drawings indicate like elements.

### DETAILED DESCRIPTION

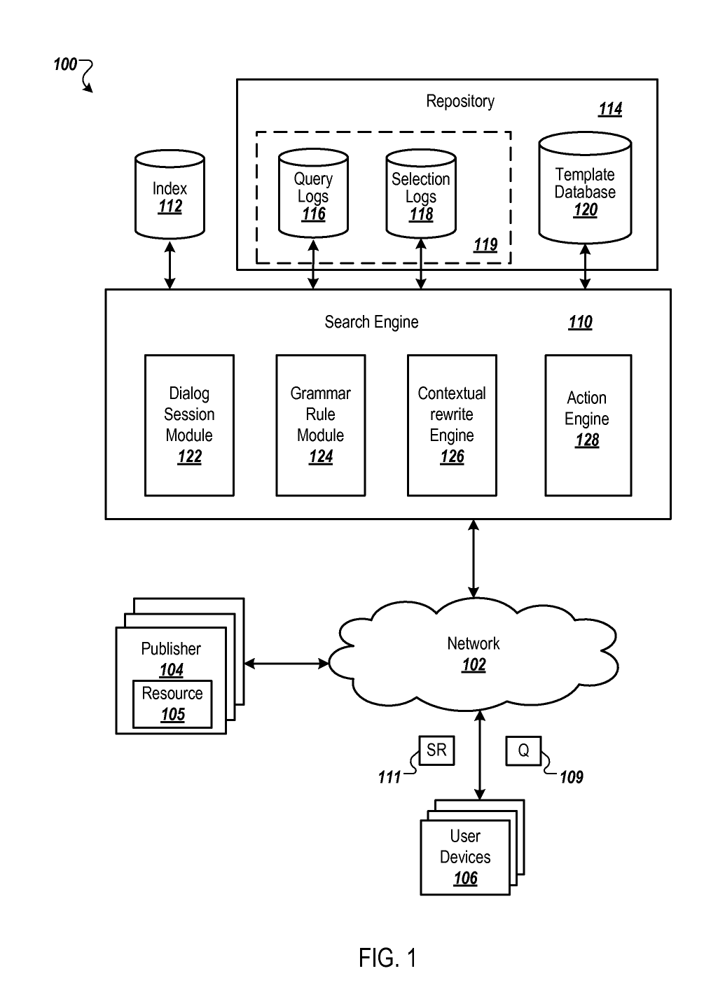

FIG. 1 is a block diagram of an example environment 100 in which a search engine is configured to rewrite contextual queries. The search engine can determine that the queries in a sequence of queries are associated with each other in a same user session, apply a grammar-based template to a query, and rewrite the query based on the grammar-based template and contextual data associated with previous queries in the same user session. The search engine may provide the rewritten query as an input for an action responsive to the query.

A computer network 102, such as a local area network (LAN), wide area network (WAN), the Internet, or a combination thereof, connects publisher websites 104, user devices 106, and a search engine 110. The online environment 100 may include many thousands of publisher websites 104 and user devices 106.

A publisher website 104 includes one or more resources 105 associated with a domain and hosted by one or more servers in one or more locations. Generally, a website is a collection of web pages formatted in hypertext markup language (HTML) that can contain text, images, multimedia content, and programming elements, for example, scripts. Each publisher website 104 is maintained by a content publisher, which is an entity that controls, manages and/or owns the publisher website 104.

A resource is any data that can be provided by a publisher website 104 over the network 102 and that has a resource address, e.g., a uniform resource locator (URL). The resources 105 may be HTML pages, electronic documents, images files, video files, audio files, and feed sources, to name just a few. The resources may include embedded information, e.g., meta information and hyperlinks, and/or embedded instructions, e.g., client-side scripts.

An example user device 106 may be capable of requesting and receiving resources over the network 102. Example user devices 106 may include personal computers, mobile communication devices, smart phones, tablets, TVs, set-top boxes (STBs), multimodal devices such as wearable computing devices, e.g., Google Glass, hybrid gesture recognition/speech recognition systems, e.g., Xbox/Kinect, automobile information systems, generic home entertainment systems, and other devices that can send and receive data over the network 102.

A user device 106 typically includes a user application, e.g., a web browser, to facilitate the sending and receiving of data over the network 102. The web browser can enable a user to display and interact with text, images, videos, audio, music and other information typically located on a web page at a website on the World Wide Web or a local area network. The user device 106 may include a microphone that enables a user to record a voice query or audible input a voice query, and/or a speaker for playing out a speech.

To facilitate searching of these resources 105, the search engine 110 identifies the resources by crawling the publisher websites 104 and indexing the resources 105 provided by the publisher websites 104. The resources 105 are indexed and the index data are stored in an index 112.

The user devices 106 submit search queries 109 to the search engine 110. The search queries 109 may in a form of a text query, a voice query, e.g., through a microphone in the user devices 106, a picture query, a video query, or the like. The search queries 109 are submitted in the form of a search request that includes the search request and, optionally, a unique identifier that identifies the user device 106 that submits the request. The unique identifier can be data from a cookie stored at the user device, or a user account identifier if the user maintains an account with the search engine 110, or some other identifier that identifies the user device 106 or the user using the user device.

In response to the search request, the search engine 110 uses the index 112 to identify resources that are relevant to the queries. The search engine 110 identifies the resources in the form of search results and returns the search results to the user devices 106 in a search results page resource 111. A search result is data generated by the search engine 110 that identifies a resource or provides information that satisfies a particular search query. A search result for a resource can include a web page title, a snippet of text extracted from the web page, and a resource locator for the resource, e.g., the URL of a web page.

The search results are ranked based on scores related to the resources identified by the search results, such as information retrieval (“IR”) scores, and optionally a separate ranking of each resource relative to other resources (e.g., an authority score). The search results are ordered according to these scores and provided to the user device according to the order.

In situations in which the systems discussed here collect personal information about users, or may make use of personal information, the users may be provided with an opportunity to control whether programs or features collect user information (e.g., information about a user's social network, social actions or activities, profession, a user's preferences, or a user's current location), or to control whether and/or how to receive content from the content server that may be more relevant to the user. In addition, certain data may be treated in one or more ways before it is stored or used, so that personally identifiable information is removed. For example, a user's identity may be treated so that no personally identifiable information can be determined for the user, or a user's geographic location may be generalized where location information is obtained (such as to a city, ZIP code, or state level), so that a particular location of a user cannot be determined. Thus, the user may have control over how information is collected about the user and used by a content server.

The search engine 110 includes a repository 114. The search queries 109 can be stored in the repository 114. The repository 114 can include contextual data associated with the search queries 109. In some cases, the contextual data includes search results responsive to the search queries 109, e.g., the web pages referenced by the search results, and metadata associated with the search queries and search results.

The user devices 106 can receive the search results page resource 111 and render the pages for presentation to users. In response to the user selecting a search result at a user device 106, the user device 106 requests the resource 105 identified by the resource locator included in the selected search result. The publisher of the publisher website 104 hosting the resource 105 receives the request for the resource from the user device 106 and provides the resource 105 to the requesting user device 106.

The search queries 109 submitted from the user devices 106 can be stored in query logs 116 in the repository 114. Selection data for the queries and the web pages referenced by the search results and selected by users are stored in selection logs 118 in the repository 114. The query logs 116 and the selection logs 118 define search history data 119 that includes data from and related to previous search requests associated with unique identifiers. The selection logs 118 represent actions taken responsive to search results provided by the search engine 110. The query logs 116 and selection logs 118 can be used to map queries submitted by user devices to resources that were identified in search results and the actions taken by users when presented with the search results in response to the queries.

In some implementations, data are associated with the identifiers from the search requests so that a search history for each identifier can be accessed. The selection logs 118 and query logs 116 can thus be used by the search engine 110 to determine the respective sequences of queries submitted by the user devices 106, the actions taken in response to the queries, and how often the queries have been submitted.

The search engine 110 can associate a search query and/or a search result for the search query with a user session in the repository 114. A user session may be defined using a specific period of time, e.g., 30 seconds, 60 seconds, or 120 seconds. The search engine 110 can determine whether sequential search queries are within the specific period of time and determine whether the sequential search queries are associated with each other.

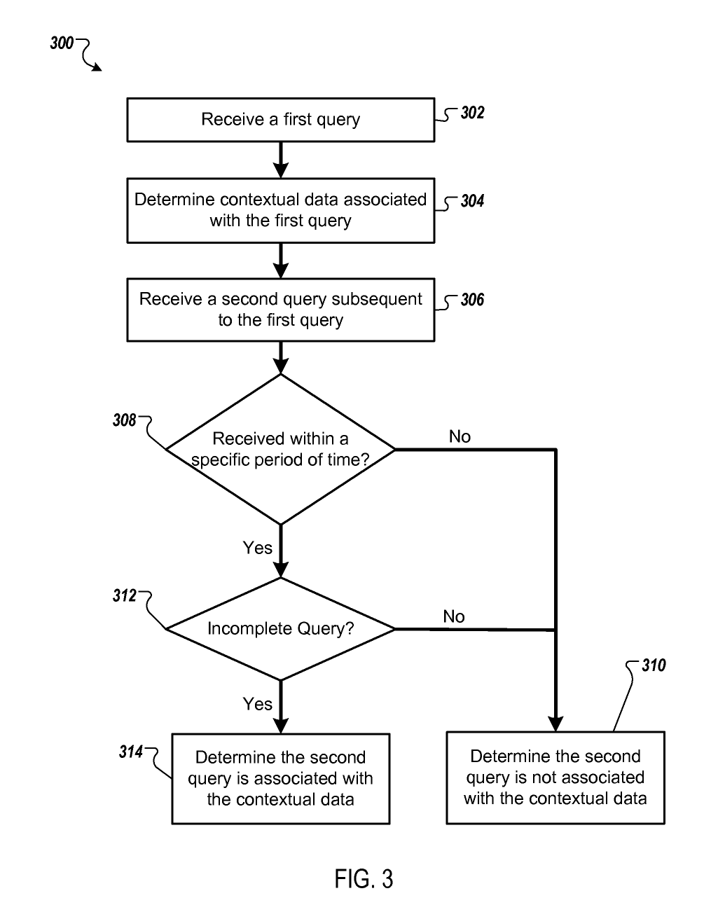

In some cases, if a query is not received within the specific period of time following a previous query, the query is determined not in the same user session as the previous query and/or the query is not associated with the previous query. In some cases, if a query is received within the specific period of time, the search engine 110 determines that the query is not associated with the previous query, e.g., by determining that the query is a complete query, as discussed in further details in FIG. 3. As a consequence of determining that the query is not associated with the previous query, the search engine 110 determines that the query is not in the same user session as the previous query and associates the query with a new user session.

In some cases, if a query is received within the specific period of time, the search engine 110 determines that the query is associated with the previous query, e.g., by determining that the query is an incomplete query, as discussed in further details in FIG. 3. As a consequence of determining that the query is associated with the previous query, the search engine 110 determines that the query is in the same user session as the previous query and provides contextual data associated with the previous query for responding to the query.

In some implementations, the repository 114 includes a template database 120 including templates for a number of vertical categories, e.g., a reminder category, a local category, or the like. The templates are determined based on the vertical categories and grammar rules. Each vertical category may include respective templates based on respective grammar rules. The respective templates for the vertical category can be applied in a number of subjects Each subject may correspond to a number of templates for different vertical categories.

In some examples, subjects for “local” may include directions, navigation, distance, calling, reviews, address, opening hours, menu, reservation, coupons, jobs, parking, businesses, weather, or the link. Templates for “local” may include:
get directions from [departure location] to [destination location]
what is the weather going to be at [location] [time]
what is the weather at [location]

In some examples, subjects for “reminder” may include flights, sports, sunset/sunrise, visits, restaurants, or the like. Templates for “reminder” may include:
remind [person] at [event time]
remind [person] [relevant time] before [event time]
remind [person] to visit [place]
remind [person] to visit [place] at [event time]
remind [person] to watch [event] at [event time]
remind [person] when [person] is near [location]
remind [person] to book [subject] at [business]

The search engine 110 can apply a specific template to a query and determine information for one or more labels in the specific template, e.g., [person], [event time], [relevant time], [place], and [location], based on the query and/or previous queries in a same user session and contextual data associated with the previous queries, e.g., stored in the repository 114.

In some implementations, the search engine 110 includes a dialog session module 122, a grammar rule module 124, a contextual rewrite engine 126, and an action engine 128. The search engine 110 may include a conversational search system. For example, the search engine 110 may include a speech-to-text engine and/or a text-to-speech engine.

In some implementations, the action engine 128 is external to the search engine 110. The action engine 128 may communicate with the search engine 110 through the network 102 or any appropriate data communications channel. The action engine 128 and the search engine 110 may be included in a server computing system.

When the search engine 110 receives a query, e.g., a text query, a voice query, or a combination thereof, the dialog session module 122 determines whether the query is received within a specific period of time for a user session subsequent to a previous query. As discussed in further details in FIG. 3, the search engine 110, e.g., the dialog session module 122, can determine whether the query is associated with the previous query. If the query is not associated with the previous query, the dialog session module 122 associates the query with a new user session, and the action engine 128 may perform a corresponding action responsive to the query.

If the query is associated with the previous query, the dialog session module 122 associates the query with the user session as the previous query. The dialog session module 122 passes the query to the grammar rule module 124. The grammar rule module 124 parses the query and/or determines a specific grammar rule for the query. The grammar rule module 124 may determine a particular template for the query based on a result of parsing the query and/or the specific grammar rule.

In some examples, the grammar rule module 124 generates the particular template based on the result and/or the specific grammar rule. In some examples, the grammar rule module 124 selects the particular template from a number of predetermined templates in the template database 120 based on the parsed result and/or the specific grammar rule, e.g., by determining that the specific grammar rule corresponds to or matches with the particular template. The grammar rule module 124 may identify one or more labels in the particular template and determine information for the labels based on the query and/or contextual data associated with the previous query. As a consequence of determining that the information is associated with the previous query, the search engine 110 determines to rewrite the second query, without providing a search result responsive to the second query.

The contextual rewrite engine 126 rewrites the second query into a third query based on the determined information and the determined particular template. In some examples, the third query has a grammar rule substantially similar to the particular template. In some examples, the contextual rewrite engine 126 generates the third query based on a grammar rule different from the particular template. In a particular example, the particular template is “remind [person] [relevant time] before [event time],” and the grammar rule for the third query “remind [person] at [exact time],” where [exact time] equals [event time]−[relevant time].

After generating the third query, the contextual rewrite engine 126 provides the third query as an input to the action engine 128. The action engine 128 performs one or more corresponding actions responsive to the third query. The actions may include a search action, a reminder action, or a navigation action.

In some examples, the action engine 128 performs a search action responsive to the third query and provides a search results webpage resource 111 and/or a text-to-speech string to a user device 106. In some examples, the action engine 128 sets up one or more reminder notices and sends the reminder notices at predetermined time points to the user device 106. In some examples, the action engine 128 performs a navigation command and gives a direction from a departure location to a destination location.

In some implementations, the search engine 110 determines grammar-based templates in the template database 120 based on historic data. The search engine 110 may get random query pairs from query logs, e.g., the query logs 116, and parse the query pairs to determine grammar-based templates for different vertical categories and/or subjects.

In some implementations, the search engine 110 creates a synthetic query pair (Q1, Q2). Q1 can be from query logs that matched predefined context subjects that can trigger reminder or navigation, e.g., flight or restaurant. In some cases, Q2 is from query logs that match predefined grammar-based templates for vertical categories, e.g., reminder, navigation, or local. In some cases, Q2 is generated based on conservation variants. For example, Q1 refers to weather, and Q2 can be generated based on data gathered for weather conservations. The conservation variants can include conservations in any suitable language, e.g., English, Chinese, Japanese, Korean, Hindi, French, Russian, or German.

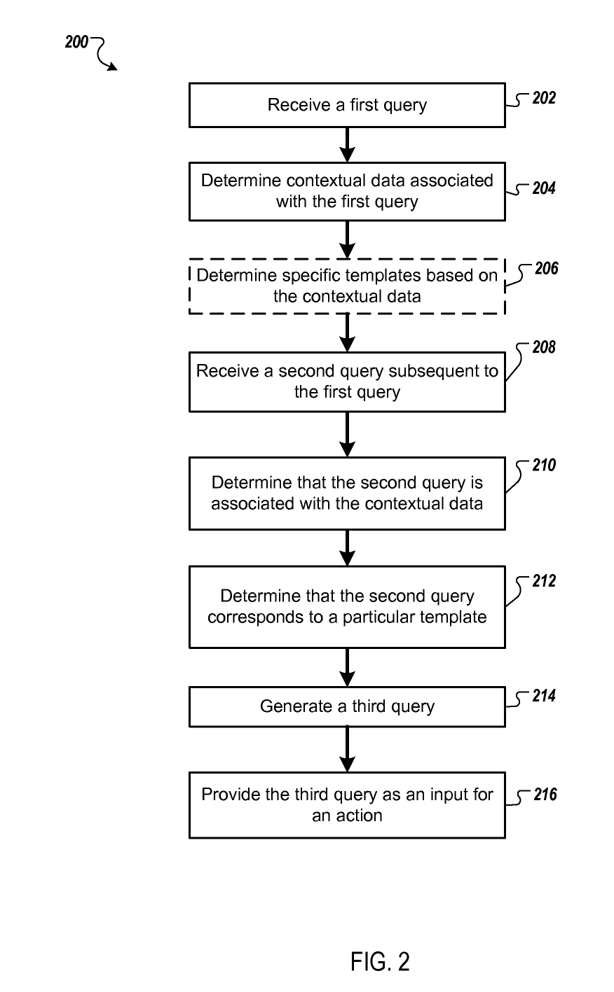

FIG. 2 depicts an example process 200 performed by a search engine. The search engine may be the search engine 110 of FIG. 1. The search engine rewrites contextual queries in a sequence of queries for a same user session.

The search engine receives a first query for a user session (202). For example, the search engine receives the first query from a user device sent by a user during the user session. The first query may be a voice query, a text query, or a combination thereof. If the first query is a voice query, the search engine may recognize and convert the voice query into a text form. The search engine may associate the first query with the user session in a repository, e.g., the repository 114 of FIG. 1.

The search engine determines contextual data associated with the first query (204). The contextual data may include a search result responsive to the first query and metadata associated with the first query and the search result. The search engine can parse the first query or a text form for the first query and perform a search action on the first query. For example, the first query may be “when is UA 214 leaving?” The search engine determines that the first query refers to a flight “UA 214” and a search result responsive to the first query is “UA 214 leaves at 2:40 pm.”

In some examples, the search engine determines metadata based on the first query. For example, the search engine may determine information about the flight “UA 214,” including departure airport and location, destination airport and location, departure gate, arrival gate, scheduled departure time and arrival time, or the like. The search engine can store and associate the metadata with the first query in the repository.

In some examples, the search engine determines metadata based on the search result responsive to the first query. For example, the first query may be “is there any flight leaving from Austin to San Francisco today?” The search result may refer to a flight “UA 214.” The search engine may further determine information about the flight “UA 214.” The search engine can store and associate the metadata with the first query in the repository. In some cases, the search engine provides the search result responsive to the first query to the user device, e.g., by providing a text-to-speech string and/or a search results pages resource, e.g., the search results pages resource 111 of FIG. 1.

Optionally the search engine determines one or more specific templates based on the contextual data (206). For example, the search engine may determine that the contextual data refers to a subject “flight” in a template database, e.g., the template database 120 of FIG. 1. The subject “flight” may be associated with one or more specific templates for one or more specific vertical categories in the template database. In a particular example, a specific template is for “reminder”: remind [person] [relevant time] before [event time]. In another particular example, a specific template is for “local”: get directions from [departure location] to [destination location]. In some implementations, the search engine stores and associates with the determined specific templates with the first query in a repository.

The search engine receives a second query subsequent to the first query (208). The second query may be received after the first query within a specific period of time defined for the user session, e.g., 60 seconds. The second query may be different from the first query. There may be no any intervening query between the first query and the second query.

The search engine determines that the second query is associated with the contextual data (210). As noted above and discussed in further details in FIG. 3, if a query is received within the specific period of time of the user session, the search engine can determine whether the second query is associated with the first query and thus the contextual data associated with the first query.

For example, the second query may be “remind me 1 hour before leaving.” The search engine determines that the second query is an incomplete query that lacks additional information required for performing a reminder action responsive to the second query. In response, the search engine determines that the second query is associated with the first query and the contextual data, and retrieves or identifies the additional information from the contextual data. The search engine may determine that the reminder action for the second query is associated with the flight “UA 214” and the second query can be interpreted as “remind me 1 hour before UA 214 leaves.”

The search engine determines that the second query corresponds to a particular template (212). The search engine can parse the second query and determine the particular template for the second query based on a result of parsing the second query. The search engine may parse the second query to determine that the second query has a specific grammar rule. In some examples, the search engine generates the particular template based on the specific grammar rule. In some examples, the search engine identifies the particular template from one or more specific templates that are predetermined or anticipated in step 206 based on the specific grammar rule.

In some examples, the search engine selects the particular template from a number of predetermined templates stored in the template database, e.g., based on the specific grammar rule of the second query and the contextual data of the first query. For example, the second query is “remind me 1 hour before leaving.” The search engine may determine that the second query corresponds to or matches with the particular template of “remind me [relative time] before [event time].”

After determining that the particular template, the search engine can identify one or more labels in the particular template, e.g., [relative time] and [event time], and determine information for the labels based on the second query and the contextual data. For example, the search engine determines that label of [relative time] is “1 hour” by comparing the particular template with the second query. The search engine determines that the label of [event time] refers to “UA 214's leaving time” or “UA 214's departure time” by comparing the particular template and the second query, and determines that “UA 214's leaving time” is “2:40 pm” from the contextual data associated with the first query and stored in the repository.

As discussed in further details in FIG. 3, in some implementations, step 212 is performed before step 210. That is, the search engine determines that the second query corresponds to a particular template and then determines that the second query is associated with the contextual data.

In a particular example, the second query is “remind me 1 hour before.” The search engine parses the second query and determines that the particular template corresponding to the second query is “remind me [relative time] before [event time].” The search engine can determine that the label “relative time” is “1 hour” based on the second query, but cannot determine what is [event time] based on the second query. As a consequence, the search engine determines that the second query is incomplete query and requires additional information to perform the reminder action responsive to the second query. The search engine may determine that the second query is associated with the first query and thus the contextual data and determine the additional information from the contextual data.

The search engine generates a third query based on the particular template, the contextual data and the second query (214). The third query may be stored and associated with the first query and/or the second query in the repository.

The search engine may generate the third query by rewriting the second query. For example, the search engine determines the information for the labels in the particular template and rewrites the second query to be “remind me 1 hour before UA 214 leaves at 2:40 pm.” The search engine may include a predefined grammar rule for time displacement and rewrite the second query based on the predefined grammar rule.

For example, the predefined grammar rule may substitute “[relative time] before [event time]” with “at [exact time],” where [exact time]=[event time]−[relative time], and/or to substitute “[relative time] after [event time]” with “at [exact time],” where [exact time]=[event time]+[relative time]. For the rewritten second query “remind me 1 hour before UA 214 leaves at 2:40 pm,” the search engine can calculate “[exact time]” to be “1:40 pm” and further rewrite the rewritten second query to “remind me at 1:40 pm for UA 214.”

In some cases, the third query has a particular grammar rule that may be based on a grammar rule of the second query and a predefined grammar rule, e.g., for time displacement. The particular grammar rule may be different from a grammar rule for the first query. For example, a grammar rule for the first query of “when is UA 214 leaving” is different from the particular grammar rule for the third query of “remind me at 1:40 pm for UA 214.”

The search engine provides the third query as an input for an action that is responsive to the second query (216). As noted above, the action may include a search action, a reminder action, or a navigation action. For example, the second query is “remind me 1 hour before leaving” that corresponds to a reminder action. In response to receiving the third query as the input, the search engine or an action engine may perform the reminder action in responsive to the second query by responding to the third query, e.g., the rewritten second query “remind me at 1:40 pm for UA 214.” The search engine or the action engine may set up a reminder notice at 1:40 pm and transmit to the user device at 1:40 pm.

FIG. 3 depicts an example process 300 performed by a search engine. The search engine may be the search engine 110 of FIG. 1 or the search engine of FIG. 2. The search engine uses the process 300 to determine whether a sequence of queries is associated with each other in a same user session.

The search engine receives a first query for a user session (302), and determines contextual data associated with the first query (304). The contextual data may include a search result responsive to the first query and metadata associated with the first query and the search result. The search engine receives a second query subsequent to the first query (306). The second query may be different from the first query. The second query may be received after the first query without any intervening query between the first query and the second query.

The search engine determines whether the second query is received after the first query within a specific period of time defined for the user session (308). If the second query is received not within the specific period of time, the search engine determines that the second query is not associated with the first query and thus not associated with the contextual data for the first query (310).

If the second query is received within the specific period of time, the search engine determines whether the second query is an incomplete query (312). The search engine may determine whether the second query lacks additional information required for performing an action responsive to the second query. The additional information cannot be determined just based on the second query.

If the search engine determines that the second query is not incomplete query, e.g., a complete query, the search engine determines that the second query is not associated with the first query and thus not associated with the contextual data (310). For example, the second query is “remind me 5 pm to buy a milk.” As the search engine can determine information required to perform the remind action responsive to the second query, e.g., the exact time “5 pm” and the event “buy a milk,” the second query is determined to be a complete query.

If the search engine determines that the second query is an incomplete query, the search engine determines that the second query is associated with the first query and thus associated with the contextual data (314). For example, the first query is “when is the giant's game,” and the second query is “remind me.” The search engine determines the second query lacks [exact time] and [event] to perform the reminder action responsive to the second query, e.g., based on a grammar rule or a predetermined template in a template database, e.g., the template database 120 of FIG. 1. In response, the search engine determines that the second query is associated with the contextual data of the first query and determines the additional information based on the contextual data.

In some examples, the search engine determines that at least one of the first query or a search result responsive to the first query is associated with a first tense and that the second query is associated with a second tense. If the second tense corresponds to or matches with the first tense, the second query is determined to be associated with the first query. If the second tense does not correspond to or match with the first tense, the second query is determined not to be associated with the first query.

In a particular example, the first query is “when is the giant's game?” The search result for the first query is “next Sunday at 3 pm.” The search engine determines that the first query and the search result are associated with a further tense. If the second query is “what is the weather,” the search engine determines that the second query is associated with a current tense, different from the further tense for the first query. As a consequence of determining that the current sense for the second query is different from the further tense for the first query, the search engine determines that the second query is not associated with the first query. In some cases, the second query is determined to be a complete query, which refers to the weather condition at a default time, e.g., the current time, and a default location, e.g., the current location. In response to determining that the second query is a complete query, the search engine determines that the second query is not associated with the first query.

If the second query is “what is the weather going to be,” the search engine determines that a tense for the second query is a further tense that is same as the tense for the first query. As a consequence of determining that the tense for the second query is the same as the tense for the first query, the search engine determines that the second query is associated with the first query and provides contextual data for the second query. In some cases, the second query is determined to be an incomplete query, which lacks information about [location] and [time] to determine the weather condition. In response to determining that the second query is an incomplete query, the search engine determines that the second query is associated with the first query and provides contextual data for the second query.

In some examples, the second query includes an explicit reference to the first query or the contextual data associated with the first query. In response, the search engine determines that the second query is associated with the first query. The explicit reference may be a linguist linking element. In some cases, the first query refers to an entity, and the second query may include a corresponding pronoun for the entity. For example, suppose that the first query is “when is the giant's game,” and the second query is “remind me when it starts.” The pronoun “it” in the second query refers to “the giant's game” in the first query. In some cases, the second query does not include the corresponding pronoun or the linguist linking element. For example, the second query may be “remind me.” In this case, the second query can be determined to be an incomplete query and thus to be associated with the first query.

Embodiments of the subject matter and the operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented as one or more computer programs, i.e., one or more modules of computer program instructions, encoded on computer storage medium for execution by, or to control the operation of, data processing apparatus. Alternatively or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially-generated propagated signal. The computer storage medium can also be, or be included in, one or more separate physical components or media (e.g., multiple CDs, disks, or other storage devices).

The operations described in this specification can be implemented as operations performed by a data processing apparatus on data stored on one or more computer-readable storage devices or received from other sources.

The term “data processing apparatus” encompasses all kinds of apparatus, devices, and machines for processing data, including by way of example a programmable processor, a computer, a system on a chip, or multiple ones, or combinations, of the foregoing The apparatus can include special purpose logic circuitry, e.g., an FPGA (field programmable gate array) or an ASIC (application-specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatus can also be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's user device in response to requests received from the web browser.

Embodiments of the subject matter described in this specification can be implemented in a computing system that includes a back-end component, e.g., as a data server, or that includes a middleware component, e.g., an application server, or that includes a front-end component, e.g., a user computer having a graphical user interface or a Web browser through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include users and servers. A user and server are generally remote from each other and typically interact through a communication network. The relationship of user and server arises by virtue of computer programs running on the respective computers and having a user-server relationship to each other. In some embodiments, a server transmits data (e.g., an HTML page) to a user device (e.g., for purposes of displaying data to and receiving user input from a user interacting with the user device). Data generated at the user device (e.g., a result of the user interaction) can be received from the user device at the server.

While this specification contains many specific implementation details, these should not be construed as limitations on the scope of what may be claimed, but rather as descriptions of features specific to particular embodiments. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

What is claimed is:

1. A method comprising:
receiving, by one or more computers, a first query for a user session;
determining, by the one or more computers, contextual data associated with the first query, the contextual data including a result responsive to the first query and metadata associated with the first query and the result;
receiving, by the one or more computers, a second query for the user session, the second query being different from the first query and subsequent to the first query;
determining, by the one or more computers, that the second query is an incomplete query without the contextual data that includes the result responsive to the first query and metadata associated with the first query and the result;
in response to determining, by the one or more computers, that the second query is an incomplete query without the contextual data that includes the result responsive to the first query and metadata associated with the first query and the result:
determining, by the one or more computers, a particular template with which the second query corresponds, the particular template being determined based on a grammar rule associated with the second query;
generating, by the one or more computers, a third query based on: (i) the particular template with which the second query corresponds, (ii) the contextual data that includes the result responsive to the first query and metadata associated with the first query and the result, and (iii) the second query; and
providing the third query as an input for an automatically generated actionable output that is responsive to the second query.

2. The method of claim 1, wherein receiving a second query for the user session comprises receiving the second query immediately subsequent to the first query without an intervening query and within a predetermined period of time for the user session.

3. The method of claim 1, further comprising determining one or more templates based on the contextual data and respective grammar rules, wherein determining a particular template with which the second query corresponds comprises:
parsing the second query; and
selecting the particular template from the one or more templates based on the parsing of the second query.

4. The method of claim 1, further comprising determining a plurality of templates based on respective vertical categories, respective subjects, and respective grammar rules, wherein determining a particular template with which the second query corresponds comprises:
determining that the second query refers to a specific subject and a specific vertical category based on at least one of the second query or the contextual data;
identifying one or more specific templates associated with the specific subject and the specific vertical category from the plurality of templates;
determining that the second query has a particular grammar rule; and
selecting the particular template from the one or more specific templates based on the particular grammar rule.

5. The method of claim 1, wherein determining that the second query is an incomplete query without the contextual data comprises determining that the second query lacks additional information required for performing an action, and wherein generating a third query comprises determining the additional information based on the contextual data.

6. The method of claim 5, wherein determining contextual data associated with the first query comprises determining that the first query refers to an entity, and wherein the additional information for the second query comprises a corresponding pronoun for the entity.

7. The method of claim 1, further comprising determining that at least one of the first query or the result responsive to the first query is associated with a first tense, wherein determining that the second query is an incomplete query without the contextual data comprises determining that a second tense for the second query corresponds to the first tense for the first query.

8. The method of claim 1, wherein generating a third query comprises:
determining information for one or more labels in the particular template based on the second query and the contextual data; and
generating the third query based on the determined information and the particular template.

9. The method of claim 8, further comprising:
identifying one or more supporting grammar rules associated with the one or more labels; and
generating the third query based on the one or more supporting grammar rules.

10. The method of claim 1, wherein the third query has a particular grammar rule corresponding to the particular template, and the particular grammar rule is different from a grammar rule for the first query.

11. The method of claim 1, wherein the action comprises at least one of a search action, a reminder action, or a navigation action.

12. A system, comprising:
a data processing apparatus; and
a non-transitory computer readable storage medium in data communication with the data processing apparatus and storing instructions executable by the data processing apparatus and upon such execution cause the data processing apparatus to perform operations comprising:
receiving a first query for a user session;
determining contextual data associated with the first query, the contextual data including a result responsive to the first query and metadata associated with the first query and the result;
receiving a second query for the user session, the second query being different from the first query and subsequent to the first query;
determining that the second query is an incomplete query without the contextual data that includes the result responsive to the first query and metadata associated with the first query and the result;
in response to determining that the second query is an incomplete query without the contextual data that includes the result responsive to the first query and metadata associated with the first query and the result:
determining a particular template with which the second query corresponds, the particular template being determined based on a grammar rule associated with the second query;
generating a third query based on: (i) the particular template with which the second query corresponds, (ii) the contextual data that includes the result responsive to the first query and metadata associated with the first query and the result, and (iii) the second query; and
providing the third query as an input for an automatically generated actionable output that is responsive to the second query.

13. The system of claim 12, wherein receiving a second query for the user session comprises receiving the second query immediately subsequent to the first query without an intervening query and within a predetermined period of time for the user session.

14. The system of claim 12, wherein the operations further comprise determining one or more templates based on the contextual data and respective grammar rules, and wherein determining a particular template with which the second query corresponds comprises:
parsing the second query; and
selecting the particular template from the one or more templates based on the parsing of the second query.

15. The system of claim 12, wherein the operations further comprise determining a plurality of templates based on respective vertical categories, respective subjects, and respective grammar rules, and wherein determining a particular template with which the second query corresponds comprises:
determining that the second query refers to a specific subject and a specific vertical category based on at least one of the second query or the contextual data;
identifying one or more specific templates associated with the specific subject and the specific vertical category from the plurality of templates;
determining that the second query has a particular grammar rule; and
selecting the particular template from the one or more specific templates based on the particular grammar rule.

16. The system of claim 12, wherein determining that the second query is an incomplete query without the contextual data comprises determining that the second query lacks additional information required for performing an action, and wherein generating a third query comprises determining the additional information based on the contextual data.

17. The system of claim 16, wherein determining contextual data associated with the first query comprises determining that the first query refers to an entity, and wherein the additional information for the second query comprises a corresponding pronoun for the entity.

18. The system of claim 12, wherein the operations further comprise determining that at least one of the first query or the result responsive to the first query is associated with a first tense, and wherein determining that the second query is an incomplete query without the contextual data comprises determining that a second tense for the second query corresponds to the first tense for the first query.

19. The system of claim 12, wherein generating a third query comprises:
determining information for one or more labels in the particular template based on the second query and the contextual data; and
generating the third query based on the determined information and the particular template.

20. The system of claim 19, wherein the operations further comprise:
identifying one or more supporting grammar rules associated with the one or more labels; and
generating the third query based on the one or more supporting grammar rules.

21. The system of claim 12, wherein the third query has a particular grammar rule corresponding to the particular template, and the particular grammar rule is different from a grammar rule for the first query.

22. The system of claim 12, wherein the action comprises at least one of a search action, a reminder action, or a navigation action.

23. A non-transitory computer readable storage medium storing instructions executable by a data processing apparatus and upon such execution cause the data processing apparatus to perform operations comprising:
receiving a first query for a user session;
determining contextual data associated with the first query, the contextual data including a result responsive to the first query and metadata associated with the first query and the result;
receiving a second query for the user session, the second query being different from the first query and subsequent to the first query;
determining that the second query is an incomplete query without the contextual data that includes the result responsive to the first query and metadata associated with the first query and the result;
in response to determining that the second query is an incomplete query without the contextual data that includes the result responsive to the first query and metadata associated with the first query and the result:
determining a particular template with which the second query corresponds, the particular template being determined based on a grammar rule associated with the second query;
generating a third query based on: (i) the particular template with which the second query corresponds, (ii) the contextual data that includes the result responsive to the first query and metadata associated with the first query and the result, and (iii) the second query; and
providing the third query as an input for an automatically generated actionable output that is responsive to the second query.

24. The computer readable storage medium of claim 23, wherein receiving a second query for the user session comprises receiving the second query immediately subsequent to the first query without an intervening query and within a predetermined period of time for the user session.

25. The computer readable storage medium of claim 23, wherein the operations further comprise determining one or more templates based on the contextual data and respective grammar rules, and wherein determining a particular template with which the second query corresponds comprises:
parsing the second query; and
selecting the particular template from the one or more templates based on the parsing of the second query.

26. The computer readable storage medium of claim 23, wherein the operations further comprise determining a plurality of templates based on respective vertical categories, respective subjects, and respective grammar rules, and wherein determining a particular template with which the second query corresponds comprises:
determining that the second query refers to a specific subject and a specific vertical category based on at least one of the second query or the contextual data;
identifying one or more specific templates associated with the specific subject and the specific vertical category from the plurality of templates;
determining that the second query has a particular grammar rule; and
selecting the particular template from the one or more specific templates based on the particular grammar rule.

27. The computer readable storage medium of claim 23, wherein determining that the second query is an incomplete query without the contextual data comprises determining that the second query lacks additional information required for performing an action, and wherein generating a third query comprises determining the additional information based on the contextual data.

28. The computer readable storage medium of claim 27, wherein determining contextual data associated with the first query comprises determining that the first query refers to an entity, and wherein the additional information for the second query comprises a corresponding pronoun for the entity.

29. The computer readable storage medium of claim 23, wherein the operations further comprise determining that at least one of the first query or the result responsive to the first query is associated with a first tense, and wherein determining that the second query is an incomplete query without the contextual data comprises determining that a second tense for the second query corresponds to the first tense for the first query.

30. The computer readable storage medium of claim 23, wherein generating a third query comprises:
determining information for one or more labels in the particular template based on the second query and the contextual data; and
generating the third query based on the determined information and the particular template.

31. The computer readable storage medium of claim 30, wherein the operations further comprise:
identifying one or more supporting grammar rules associated with the one or more labels; and
generating the third query based on the one or more supporting grammar rules.

32. The computer readable storage medium of claim 23, wherein the third query has a particular grammar rule corresponding to the particular template, and the particular grammar rule is different from a grammar rule for the first query.

33. The computer readable storage medium of claim 23, wherein the action comprises at least one of a search action, a reminder action, or a navigation action.

34. (canceled)
